(19) United States
(12) Patent Application Publication
(10) Pub. No.: US 2012/0176304 A1
(43) Pub. Date: Jul. 12, 2012

(54) PROJECTION DISPLAY APPARATUS

(75) Inventors: Fuminori MIZUNO, Osaka (JP); Masutaka Inoue, Osaka (JP); Makoto Maeda, Nata City (JP); Naoyuki Nimura, Osaka (JP)

(73) Assignee: SANYO ELECTRIC CO., LTD., Osaka (JP)

(21) Appl. No.: 13/307,286

(22) Filed: Nov. 30, 2011

(30) Foreign Application Priority Data
Jan. 7, 2011 (JP) 2011-002249

(51) Int. Cl. G06F 3/01

(52) U.S. Cl. 345/156

(57) ABSTRACT

A projection display apparatus includes: an element controller that controls an imager to display a maximum light amount image and a minimum light amount image; a setting unit that sets a light amount threshold value used to detect pointing light emitted from a pointing device; and a specifying unit that specifies a light amount of the pointing light overlapping the minimum light amount image, based on a picked-up image, and to specify a light amount of the maximum light amount image, based on the picked-up image, wherein the setting unit sets the light amount threshold value, based on the specified light amount of the pointing light and the specified light amount of the maximum light amount image.

### CROSS REFERENCE TO RELATED APPLICATIONS

This application is based upon and claims the benefit of priority from prior Japanese Patent Application No. 2011-002249 filed on Jan. 7, 2011; the entire content of which is incorporated herein by reference.

### BACKGROUND OF THE INVENTION

1. Field of the Invention

The present invention relates to a projection display apparatus including an imager that modulates light emitted from a light source and a projection unit that projects light emitted from the imager onto a projection plane.

2. Description of the Related Art

Conventionally, there has been disclosed a projection display apparatus provided with a light source, an imager that modulates light emitted from the light source, and a projection unit that projects light emitted from the imager onto a projection plane.

It is also known a projection display apparatus that provides an interactive function by using a pointing device (interactive pen) that outputs pointing light toward a projection plane (for example, see Japanese Unexamined Patent Application Publication No. 2008-15560).

Specifically, the projection display apparatus captures an image projected onto the projection plane as well as the pointing light by using an image pick-up element, and coordinates of the pointing light are thereby specified in the image projected on the projection plane.

As described above, when the interactive function is put to use, it is necessary to specify the coordinates of the pointing light in the image projected on the projection plane. That is, it is necessary to detect the pointing light in the image projected on the projection plane.

However, if a light amount of the pointing light is inadequately small, then the pointing light is scattered in the image projected on the projection plane. In this case, the pointing light cannot be detected. Moreover, it can be assumed that a user uses various types of pointing devices, and thus, it is difficult to specify a light amount of pointing light beforehand.

### SUMMARY OF THE INVENTION

A projection display apparatus (projection display apparatus 100) according to a first feature is provided with an imager (liquid crystal panel 30) that modulates light emitted from a light source, and a projection unit (projection unit 50) that projects light emitted from the imager onto a projection plane. The projection display apparatus includes: an acquisition unit (acquisition unit 220) that acquires a picked-up image from an image pick-up element capturing the projection plane; an element controller (element controller 250) that controls the imager to display a maximum light amount image and a minimum light amount image; a setting unit (setting unit 240) that sets a light amount threshold value used to detect pointing light emitted from a pointing device; and a specifying unit (specifying unit 230) that specifies a light amount of the pointing light overlapping the minimum light amount image, based on the picked-up image, and to specify a light amount of the maximum light amount image, based on the picked-up image. The setting unit sets the light amount threshold value, based on the specified light amount of the pointing light and the specified light amount of the maximum light amount image.

In the first feature, the projection display apparatus further includes a light-amount adjustment unit (light-amount adjustment unit 270) that adjusts a light amount of the image projected onto the projection plane, such that the light amount of the maximum light amount image is smaller than the specified light amount of the pointing light.

In the first feature, when the image pick-up element can detect light of the same color as the pointing light, the light-amount adjustment unit adjusts the light amount of the image projected onto the projection plane, such that a maximum light amount of image light of the same color as the pointing light is smaller than the specified light amount of the pointing light.

In the first feature, when the specified light amount of the pointing light is smaller than the specified light amount of the maximum light amount image, the element controller controls the imager to display a guide image giving an instruction to relatively increase the light amount of the pointing light relative to the light amount of the image projected onto the projection plane.

In the first feature, the setting unit sets the light amount threshold value for each of a plurality of areas constituting the projection plane.

A projection display apparatus according to a second feature provided with an imager that modulates light emitted from a light source, and a projection unit that projects light emitted from the imager onto a projection plane. The projection display apparatus includes: an acquisition unit that acquires a picked-up image from an image pick-up element capturing the projection plane; a specifying unit that specifies a light amount of invisible pointing light emitted from a pointing device, based on the picked-up image; and an element controller that controls the imager to display a guide image giving an instruction to relatively increase the light amount of the pointing light relative to the light amount of the image projected onto the projection plane, when the specified light amount of the pointing light is smaller than a light amount threshold value.

### BRIEF DESCRIPTION OF THE DRAWINGS

FIG. 1 is a diagram illustrating a projection display apparatus 100 according to a first embodiment;

FIG. 2 is a block diagram illustrating a control unit 200 according to the first embodiment;

FIG. 3 is a diagram for explaining how to set a light amount threshold value according to the first embodiment;

FIG. 4 is a diagram for explaining a maximum light amount image and a minimum light amount image according to the first embodiment;

FIG. 5 is a diagram for explaining the maximum light amount image and the minimum light amount image according to the first embodiment;

FIG. 6 is a diagram for explaining a guide image according to the first embodiment;

FIG. 7 is a diagram for explaining the guide image according to the first embodiment;

FIG. 8 is a diagram for explaining how to adjust a light amount according to the first embodiment;

FIG. 9 is a diagram for explaining how to adjust the light amount according to the first embodiment;

FIG. 10 is a diagram for explaining how to detect pointing light according to a first modification; and

FIG. 11 is a diagram for explaining how to detect pointing light according to the first modification.

### MODES FOR CARRYING OUT THE INVENTION

Hereinafter, a projection display apparatus according to an embodiment of the present invention is described with reference to drawings. Note that in the descriptions of the drawing, identical or similar symbols are assigned to identical or similar portions.

### Overview of Embodiment

A projection display apparatus according to an embodiment of the present invention includes an imager that modulates light emitted from a light source, and a projection unit that projects light emitted from the imager onto a projection plane. The projection display apparatus includes: an acquisition unit that acquires a picked-up image from an image pick-up element that captures the projection plane; an element controller that controls the imager to display a maximum light amount image and a minimum light amount image; a setting unit that sets a light amount threshold value used to detect pointing light emitted from a pointing device; and a specifying unit that specifies a light amount of the pointing light overlapping the minimum light amount image, based on the picked-up image, and to specify a light amount of the maximum light amount image, based on the picked-up image. The setting unit sets the light amount threshold value, based on the specified light amount of the pointing light and the specified light amount of the maximum light amount image.

In this embodiment, the setting unit sets the light amount threshold value, based on the specified light amount of the pointing light and the specified light amount of the maximum light amount image. Therefore, it is possible to detect the pointing light appropriately, even when a user uses various types of pointing devices.

In this embodiment, the specifying unit specifies the light amount of the pointing light overlapping the minimum light amount image. Therefore, the setting unit can set the appropriate light amount threshold value while eliminating an influence of brightness (an amount of external light) around the projection display apparatus.

In the following embodiment, a description will be given when the projection display apparatus has the interactive function. The projection display apparatus is provided also with an image pick-up element that captures the projection plane.

### First Embodiment

### (Configuration of Projection Display Apparatus)

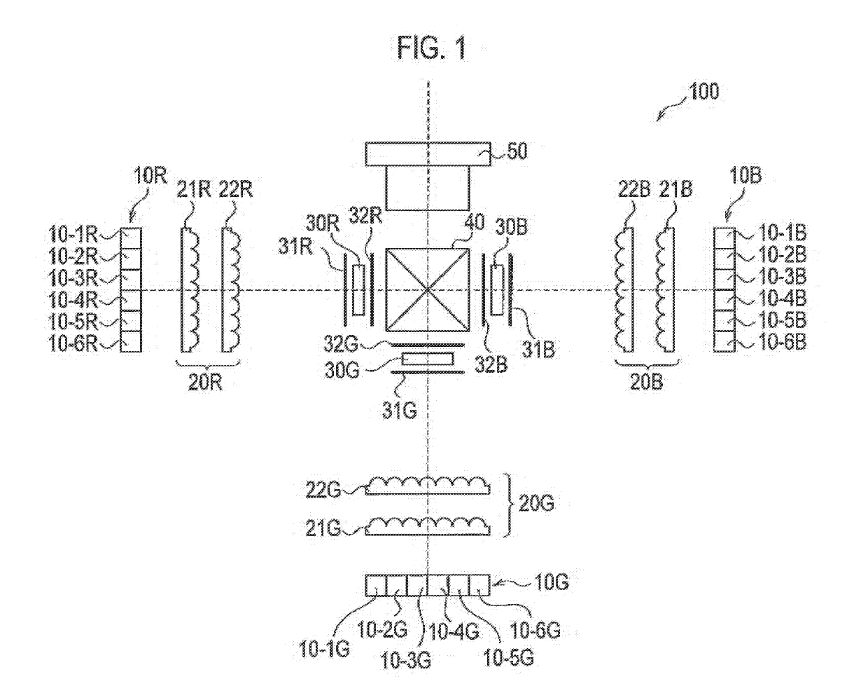

A description will be given below of the configuration of a projection display apparatus according to a first embodiment, with reference to accompanying drawings. FIG. 1 illustrates the configuration of a projection display apparatus 100 according to the first embodiment.

As illustrated in FIG. 1, the projection display apparatus 100 includes a plurality of light source units 10, a plurality of fly-eye lens units 20, a plurality of liquid crystal panels 30, a cross dichroic prism 40, and a projection unit 50.

The plurality of light source units 10 include a light source unit 10R, a light source unit 10G, and a light source unit 10B. Each light source unit 10 is configured by a plurality of solid light sources. Examples of the solid light source include an LD (Laser Diode) and an LED (Light Emitting Diode). The light source unit 10R is configured by a plurality of solid light sources (10-1R to 10-6R) that emits red component light R. The light source unit 100 is configured by a plurality of solid light sources (10-1G to 10-6G) that emits green component light G. The light source unit 10B is configured by a plurality of solid light sources (10-1B to 10-6B) that emits blue component light B.

The plurality of fly eye lens units 20 include a fly eye lens unit 20R, a fly eye lens unit 200, and a fly eye lens unit 20B. Each fly eye lens unit 20 is configured by a fly eye lens 21 and a fly eye lens 22. The fly eye lens 21 and the fly eye lens 22 are configured by a plurality of minute lenses, respectively. Each minute lens collects the light emitted by each light source unit 10 so that the entire surface of each liquid crystal panel 30 is irradiated with the light emitted by each light source unit 10.

The plurality of liquid crystal panels 30 include a liquid crystal panel 30R, a liquid crystal panel 300G, and a liquid crystal panel 30B. The liquid crystal panel 30R modulates the red component light R by rotating a polarization direction of the red component light R. On a light incidence surface side of the liquid crystal panel 30R, an incidence-side polarization plate 31R that transmits light having one polarization direction (for example, a P-polarization) and shield light having another polarization direction (for example, an S-polarization) is arranged. On a light exit surface side of the liquid crystal panel 30R, an exit-side polarization plate 32R that shields light having one polarization direction (for example, a P-polarization) and transmit light having another polarization direction (for example, an S-polarization) is arranged.

Similarly, the liquid crystal panel 30G and the liquid crystal panel 30B modulate the green component light G and the blue component light B by rotating polarization directions of the green component light G and the blue component light B, respectively. On a light incidence surface side of the liquid crystal panel 300, an incidence-side polarization plate 31G is arranged, and on a light exit surface side of the liquid crystal panel 30G, an exit-side polarization plate 320 is arranged. On a light incidence surface side of the liquid crystal panel 30B, an incidence-side polarization plate 31B is arranged, and on a light exit surface side of the liquid crystal panel 30B, an exit-side polarization plate 32B is arranged.

The cross dichroic prism 40 combines light beams that have exited the liquid crystal panel 30R, the liquid crystal panel 30G, and the liquid crystal panel 30B. The cross dichroic prism 40 outputs the combined light to the projection unit 50 side.

The projection unit 50 projects the combined light (image light) output from the cross dichroic prism 40, onto a screen, etc.

### (Configuration of Control Unit)

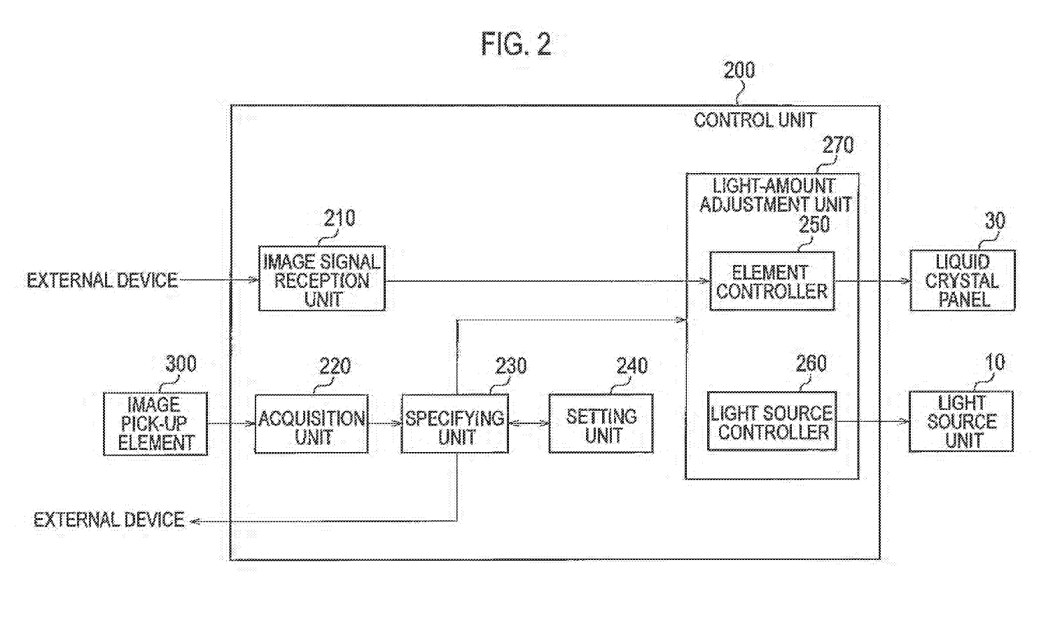

Hereinafter, the control unit according to the first embodiment will be described with reference to the accompanying drawings. FIG. 2 is a block diagram illustrating a control unit 200 according to the first embodiment. The control unit 200 is arranged in the projection display apparatus 100 and controls the projection display apparatus 100.

The control unit 200 converts an image input signal into an image output signal. The image input signal is configured by a red input signal Rᵢₙ, a green input signal. Gᵢₙ, and a blue input signal Bᵢₙ. The image output signal is configured by a red output signal Rₒᵤₜ, a green output signal Gₒᵤₜ, and a blue output signal Bₒᵤₜ. The image input signal and the image output signal are signals that are input in a respective one of a plurality of pixels configuring one frame.

It is noted that lower limit values of the image output signal and the image output signal are “0”, for example, and upper limit values of the image output signal and the image output signal are “255”, for example.

As illustrated in FIG. 2, the control unit 200 includes an image signal reception unit 210, an acquisition unit 220, a specifying unit 230, a setting unit 240, an element controller 250, and a light source controller 260. The element controller 250 and the light source controller 260 configure a light-amount adjustment unit 270 that adjusts an amount of image light projected onto the projection plane.

The image signal reception unit 210 receives the image input signal from an external device (not shown) such as a personal computer.

The acquisition unit 220 acquires a picked-up image of the projection plane from the image pick-up element 300 that captures the projection plane.

The image pick-up element 300 detects the amount of light reflected on the projection plane. The image pick-up element 300 may be that detects the red component light R, the green component light G, and the blue component light B independently of one another. Alternatively; the image pick-up element 300 may be that detects an amount of light in which the red component light R, the green component light G, and the blue component light B are combined. Alternatively, the image pick-up element 300 may be that detects invisible light such as ultraviolet light or infrared light.

The specifying unit 230 detects pointing light overlapping the image projected onto the projection plane, based on the picked-up image acquired from the image pick-up element 300. For details, the specifying unit 230 detects the pointing light overlapping the image projected onto the projection plane, based on a light amount threshold value set by the setting unit 240 described later.

In this case, the pointing light is output from a pointing device. The pointing light may be either visible light or invisible light.

The specifying unit 230 detects coordinates of the pointing light, in the image projected onto the projection plane. The specifying unit 230 outputs the coordinates of the pointing light to an external device.

In the first embodiment, during a process of setting the light amount threshold value, the specifying unit 230 specifies the light amount of the pointing light overlapping the minimum light amount image, based on the picked-up image. In addition, the specifying unit 230 specifies the light amount of the maximum light amount image, based on the picked-up image.

In this case, the minimum light amount image is an image having the minimum amount of light that is projected onto the projection plane. The minimum light amount image may be, for example, a black image. It should be noted that when the image pick-up element 300 can detect light of the same color as the pointing light, the light of the same color as the pointing light may simply have the minimum light amount in the minimum light amount image. That is, when the pointing light has a red color, the minimum light amount image may be, for example, any image that does not contain a red color, and may even be an image containing green and blue colors.

The maximum light amount image is an image having the maximum amount of light that is projected onto the projection plane. The maximum light amount image may be, for example, a white image. It should be noted that when the image pick-up element 300 can detect light of the same color as the pointing light, the light of the same color as the pointing light may simply have the maximum light amount in the maximum light amount image. That is, when the pointing light has a red color, the maximum light amount image may be, for example, any image that contains a red color of the maximum light amount, and may even be an image that does not contain green and blue colors.

The setting unit 240 sets the light amount threshold value used to detect the pointing light emitted from the pointing device. Specifically, the setting unit 240 sets the light amount threshold value, based on the light amount of the pointing light that has been specified by the specifying unit 230, and based on the light amount of the maximum light amount image that has been specified by the specifying unit 230.

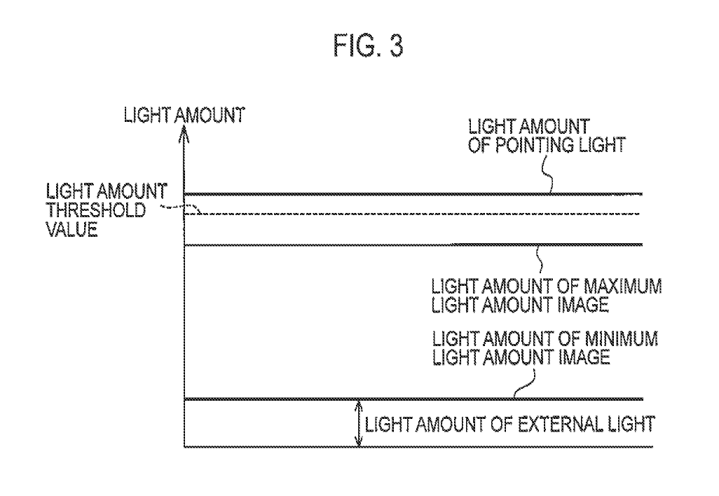

For details, the setting unit 240 sets, as the light amount threshold value, a value that is smaller than the light amount of the pointing light and larger than that of the maximum light amount image, as illustrated in FIG. 3. Note that the light amount of the minimum light amount image can be regarded as an amount of external light.

It is obvious that the light amount threshold value is a threshold value relating to the light of the same color as the pointing light, when the image pick-up element 300 can detect light of the same color as the pointing light.

The element controller 250 converts the image input signal into the image output signal, and controls the liquid crystal panel 30 based on the image output signal.

First, the element controller 250 controls the liquid crystal panel 30 such that the maximum light amount image and the minimum light amount image are displayed. Note that the maximum light amount image and the minimum light amount image may be provided either in a single frame or different frames.

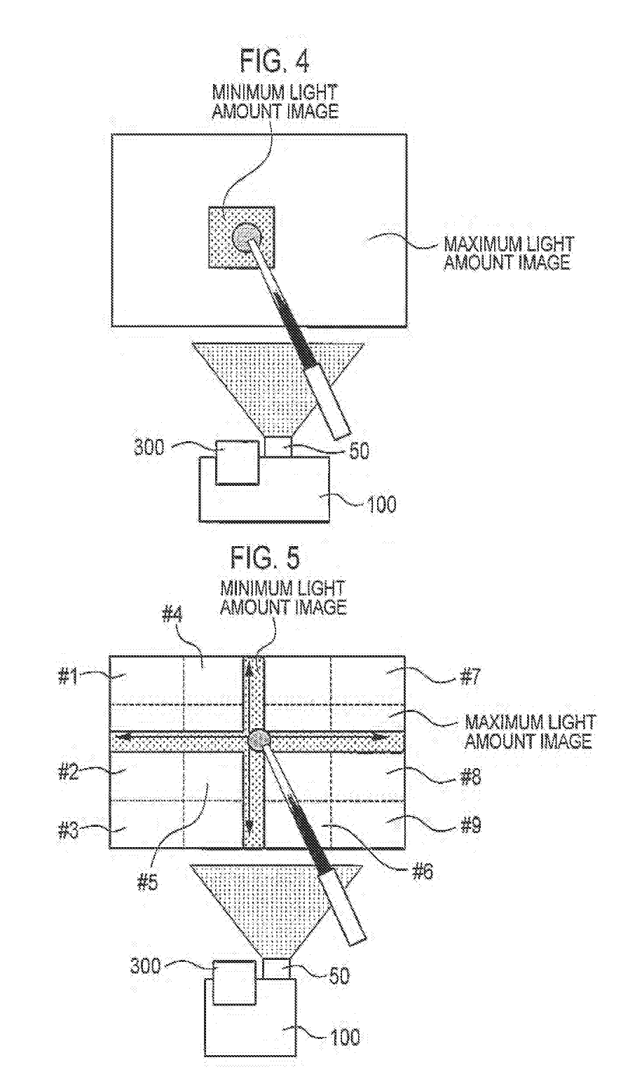

For example, the minimum light amount image may be an image displayed in any given area of the projection plane, as illustrated in FIG. 4. In this case, the maximum light amount image is displayed in an area other than the area where the minimum light amount image is displayed.

Alternatively, the minimum light amount image may be an image displayed across a plurality of areas (in this case, areas #2, #4, #5, #6, and #8), as illustrated in FIG. 5. For example, it is preferable that the minimum light amount image include a band-shaped image displayed laterally across the whole of the projection plane. Alternatively, it is preferable that the minimum light amount image include a band-shaped image displayed vertically across the whole of the projection plane. Note that the minimum light amount image may be discontinuous.

When the minimum light amount image illustrated in FIG. 5 is employed, it is preferable that the above-described setting unit 240 set a light amount threshold value for each of a plurality of areas. It is obvious that the above-described specifying unit 230 specifies, for each of a plurality of areas, the light quantities of the pointing light overlapping the minimum light amount image.

As to a target area which does not contain the minimum light amount image, the setting unit 240 sets a light amount threshold value of this area, based on the light amount threshold values set for areas arranged around the target area. For example, the setting unit 240 sets a light amount threshold value of the area #1, based on the light amount threshold values set for the areas #2 and #4.

It is preferable that the element controller 250 control the liquid crystal panel 30 such that an image giving an instruction to overlap the pointing light on the minimum light amount image is displayed. This image may contain a message saying “Please apply the pointing light over the minimum light amount image”, and a message saying “Please move the pointing light along the minimum light amount image”, for example.

Second, the element controller 250 controls the liquid crystal panel 30 to display, when the light amount of the pointing light is smaller than that of the maximum light amount image, a guide image giving an instruction to relatively increase the light amount of the pointing light relative to that of the image projected onto the projection plane.

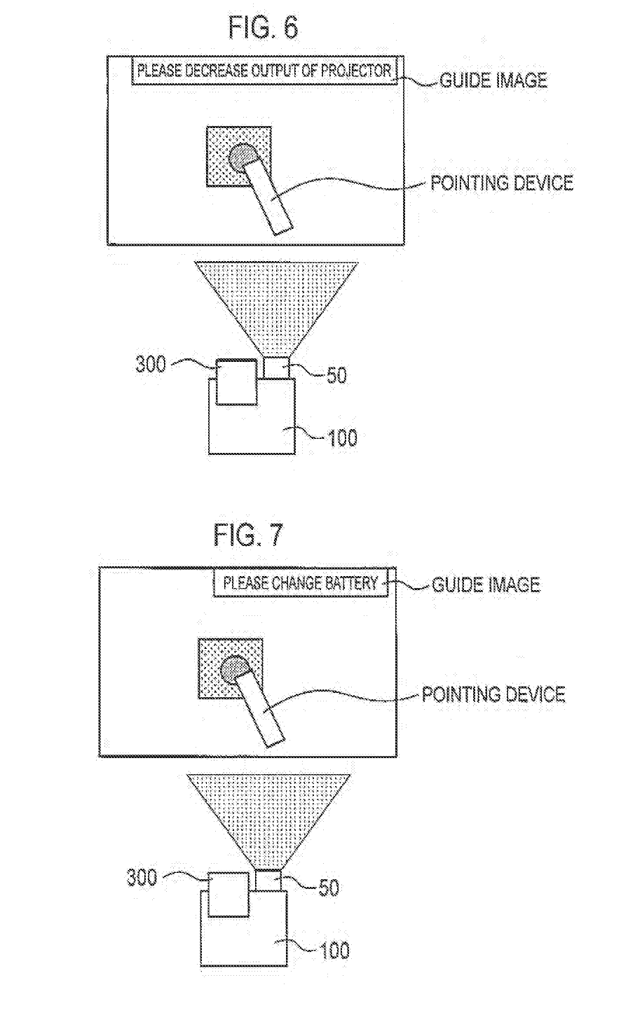

For example, the guide image is an image giving an instruction to decrease the light amount of the image projected onto the projection plane. As illustrated in FIG. 6, the guide image may contain a message saying “Please decrease the output of the projector”. The guide image may also contain a message saying “Please move the projector away from the projection plane”.

Alternatively, the guide image is an image giving an instruction to increase the light amount of the pointing light. As illustrated in FIG. 7, the guide image may contain a message saying “Please change the battery (of the pointing device)”. The guide image may also contain a message saying “Please increase the output of the pointing device”.

The light source controller 260 controls the light source unit 10. For example, the light source controller 260 controls a backlight and the like.

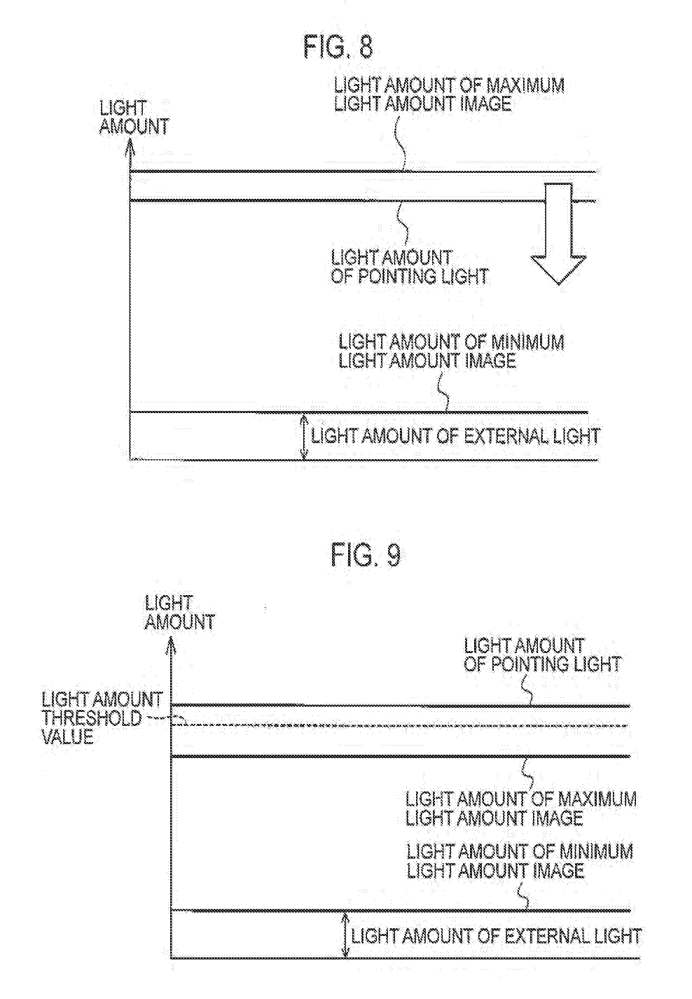

When the light amount of the pointing light is smaller than that of the maximum light amount image as illustrated in FIG. 8, the light-amount adjustment unit 270 may automatically adjust the maximum light amount of the image projected onto the projection plane. Specifically, as illustrated in FIG. 9, the light-amount adjustment unit 270 decreases the maximum light amount of the image projected onto the projection plane so that the light amount of the pointing light is larger than that of the maximum light amount image.

The element controller 250 may control the liquid crystal panel so that the maximum light amount of the image projected onto the projection plane decreases. Alternatively, the light source controller 260 may control the light source units 10 so that the maximum light amount of the image projected onto the projection plane decreases.

In this case, when the image pick-up element 300 can detect light of the same color as the pointing light, it is preferable that the light-amount adjustment unit 270 adjust the light amount of the image projected onto the projection plane so that the maximum light amount of image light of the same color as the pointing light is decreased.

### (Operation and Effect)

In the first embodiment, the setting unit 240 sets the light amount threshold value, based on the specified light amount of the pointing light and the specified light amount of the maximum light amount image. This enables the projection display apparatus to appropriately detect the pointing light, even when a user uses various types of pointing devices.

In the first embodiment, the specifying unit 230 specifies the light amount of the pointing light overlapping the minimum light amount image. Therefore, the setting unit 240 can set the appropriate light amount threshold value while eliminating an influence of brightness (an amount of external light) around the projection display apparatus.

In the first embodiment, the setting unit 240 sets a light amount threshold value for each of the plurality of areas. This makes it possible to set the appropriate light amount threshold values in accordance with a difference in a distance between the projection unit 50 and the projection plane.

### [First Modification]

A description will be given below of a first modification of the first embodiment. The following description will be focused on only a difference between the first embodiment and the first modification.

Specifically, in the first modification, a pointing device that outputs visible pointing light (visible light), and a pointing device that outputs invisible pointing light (invisible light) are used.

In this case, obviously the image pick-up element 300 has a detection element that detects light of the same color as the pointing light.

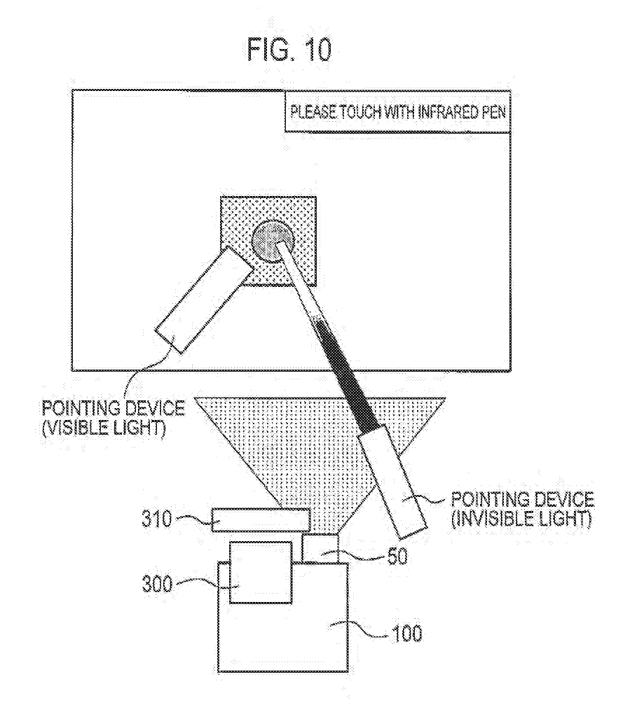

For example, when the visible pointing light is red light and the invisible pointing light is infrared light, preferably a cut filter 310 is placed at a light fetching unit of the image pick-up element 300, as illustrated in FIG. 10. The cut filter 310 is a filter that blocks unwanted light (green component light G, blue component light B, etc.).

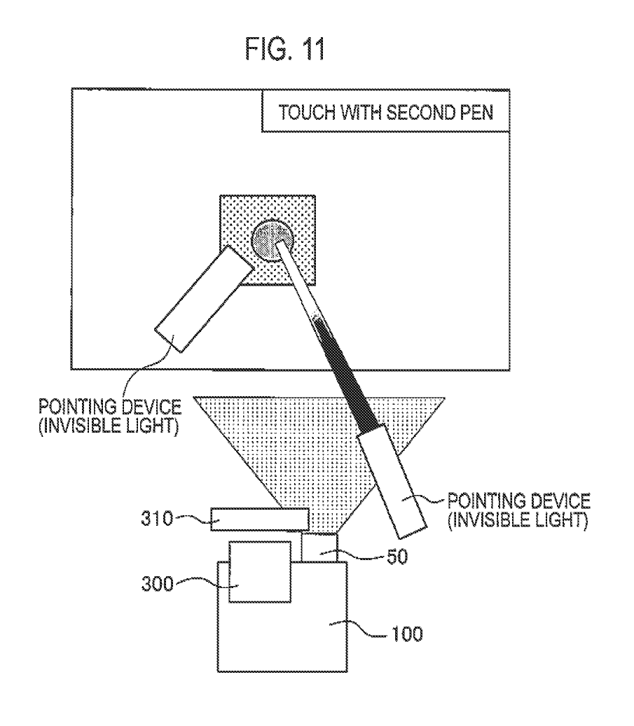

The above-described element controller 250 controls the liquid crystal panel 30 such that an image giving an instruction to overlap pointing light on the minimum light amount image is displayed. This image may contain a message indicating the type of a pointing device, or for example, a massage saying “Please touch with the infrared pen”, as illustrated in FIG. 10. Alternatively, the image may contain a message indicating the type of a pointing device, or for example, a message saying “Please touch with the second pen”, as illustrated in FIG. 11.

### [Second Modification]

A description will be given below of a second modification of the first embodiment. The following description will be focused on only a difference between the first embodiment and the second modification.

Specifically, in the second modification, the pointing light emitted from the pointing device is invisible light such as ultraviolet light or infrared light.

In such a case, displaying of the maximum light amount image and the minimum light amount image is not essential. For example, the light amount threshold value has a preset value.

The above-described element controller 250 controls the liquid crystal panel 30, when the light amount of the pointing light is smaller than the light amount threshold value, to display a guide image giving an instruction to relatively increase the light amount of the pointing light relative to that of the image projected onto the projection plane.

For example, the guide image may contain a message saying “Please change the battery (of the pointing device)”, as illustrated in FIG. 7.

### Other Embodiments

The present invention is explained through the above embodiment, but it must not be assumed that this invention is limited by the statements and the drawings constituting a part of this disclosure. From this disclosure, various alternative embodiments, examples, and operational technologies will become apparent to those skilled in the art.

In this embodiment, the liquid crystal panel 30 is used as the imager. However, the embodiment of the present invention is not limited thereto. Alternatively, an LCOS (Liquid Crystal on Silicon), a DMD (Digital Micromirror Device) or the like may be used as the imager.

In the embodiment, each light source unit 10 is composed of solid light sources such as LDs or LEDs. However, the embodiment is not limited thereto. Alternatively, each light source unit 10 may be composed of a UHP lamp or a white light source such as a xenon lamp.

What is claimed is:

1. A projection display apparatus provided with an imager that modulates light emitted from a light source, and a projection unit that projects light emitted from the imager onto a projection plane, the apparatus comprising:
an acquisition unit that acquires a picked-up image from an image pick-up element capturing the projection plane;
an element controller that controls the imager to display a maximum light amount image and a minimum light amount image;
a setting unit that sets a light amount threshold value used to detect pointing light emitted from a pointing device; and
a specifying unit that specifies a light amount of the pointing light overlapping the minimum light amount image, based on the picked-up image, and to specify a light amount of the maximum light amount image, based on the picked-up image, wherein
the setting unit sets the light amount threshold value, based on the specified light amount of the pointing light and the specified light amount of the maximum light amount image.

2. The projection display apparatus according to claim 1, further comprising a light-amount adjustment unit that adjusts a light amount of the image projected onto the projection plane, such that the light amount of the maximum light amount image is smaller than the specified light amount of the pointing light.

3. The projection display apparatus according to claim 2, wherein when the image pick-up element can detect light of the same color as the pointing light, the light-amount adjustment unit adjusts the light amount of the image projected onto the projection plane, such that a maximum light amount of image light of the same color as the pointing light is smaller than the specified light amount of the pointing light.

4. The projection display apparatus according to claim 1, wherein when the specified light amount of the pointing light is smaller than the specified light amount of the maximum light amount image, the element controller controls the imager to display a guide image giving an instruction to relatively increase the light amount of the pointing light relative to the light amount of the image projected onto the projection plane.

5. The projection display apparatus according to claim 1, wherein the setting unit sets the light amount threshold value for each of a plurality of areas constituting the projection plane.

6. A projection display apparatus provided with an imager that modulates light emitted from a light source, and a projection unit that projects light emitted from the imager onto a projection plane, the apparatus comprising:
an acquisition unit that acquires a picked-up image from an image pick-up element capturing the projection plane;
a specifying unit that specifies a light amount of invisible pointing light emitted from a pointing device, based on the picked-up image; and
an element controller that controls the imager to display a guide image giving an instruction to relatively increase the light amount of the pointing light relative to the light amount of the image projected onto the projection plane, when the specified light amount of the pointing light is smaller than a light amount threshold value.
